(19) United States
(12) Patent Application Publication
(10) Pub. No.: US 2019/0097446 A1
(43) Pub. Date: Mar. 28, 2019

(54) APPARATUS AND METHOD FOR CONTROLLING CHARGE AND DISCHARGE, AND PROGRAM

(71) Applicant: NEC Corporation, Tokyo (JP)

(72) Inventor: Hideyuki HASEGAWA, Tokyo (JP)

(73) Assignee: NEC Corporation, Tokyo (JP)

(21) Appl. No.: 16/086,854

(22) PCT Filed: Feb. 23, 2017
(86) PCT No.: PCT/JP2017/006896

§ 371 Date: Sep. 20, 2018

(30) Foreign Application Priority Data
Mar. 23, 2016 (JP) 2016-059287

(51) Int. Cl. H02J 7/00; H02J 7/02; H02J 7/35; H02J 7/34; H02J 3/32

(52) U.S. Cl. CPC H02J 7/0068; H02J 7/02; H02J 3/32; H02J 7/34; H02J 7/35

(57) ABSTRACT

The charging and discharging control apparatus includes an acquisition unit that acquires at least one of a direction and magnitude of electric power flowing between an AC power line and power system, and a control unit that controls charging of the power storage apparatus based on a change in at least one of the direction and magnitude of electric power flowing between the AC power line and power system when a charging amount to the power storage apparatus is increased by a predetermined amount.

### TECHNICAL FIELD

The present invention relates to an apparatus and a method for controlling charge and discharge, and a program.

### BACKGROUND ART

Patent Document 1 describes an example of a power supply system in which a so-called peak shift operation is performed, that is, charging of the output of a photovoltaic power generation apparatus is performed in a power storage apparatus during a daytime zone and discharging is performed during a nighttime zone so that electric power is supplied to a load apparatus. In the system described in Patent Document 1, a charging and discharging amount of the power storage apparatus is predicted from the demand prediction data of the load apparatus and power generation output prediction data predicted using weather forecast data, and based on the predicted values, stable power supply to the load apparatus is implemented by controlling a power generation amount of the power generation apparatus or by suppressing the electric power consumption of an adjustment load apparatus.

The following analysis is given by the present invention. As described in Non-Patent Documents 1 and 2, in recent years, a surplus electric power flowing back to a power system has increased due to a rapid increase of distributed type power supply (power generation apparatus) using renewable energy centering on sunlight, and there is a problem that the power system becomes unstable.

Non-Patent Document 1 describes that since it is predicted that stable supply of electric power becomes difficult with a rapid expansion of renewable energy centering on sunlight in a certain area, a connectable amount is verified and, when an output exceeds the connectable amount, power output control is executed. Here the power output control is for restricting an amount of electric power flowing back to the power system to stabilize the power system. Specifically, in the power output control, an amount of electric power to be generated in the power generation apparatus is controlled to a predetermined amount of electric power by a Power Conditioning System (PCS), and the electric power is made to flow back to the power system. Non-Patent Document 1 also states that in the future, small photovoltaic power generation facilities for home use and the like are scheduled to be subjected to the power output control.

Non-Patent document 2 describes a method of operating power output control. For power output control, there are methods of operating surplus purchase and operating full amount purchase. In surplus control, in a case where a self-consumption electric power amount exceeds a power output control value (some % of the rated power output of PCS), it is possible to control a backflow to the power system to be equal to zero. That is, the control is performed so that a value obtained by subtracting the self-consumption electric power amount from the generated electric power amount of the power generation apparatus is equal to zero.

### RELATED DOCUMENT

### Patent Document

[Patent Document 1] Japanese Laid-open Patent Publication No. 2013-176234

### Non-Patent Document

[Non-Patent Document 1] “Kyushu hondo no saisei kano enerugi hatsuden setsubi ni taisuru setsuzoku moshikomi no kaito saikai ni kansuru gosetsumei shiryo (An explanatory material on resumption of reply to application for connection to renewable energy power generation facilities in Kyushu mainland)”, [online], February 2015, Kyushu Electric Power Co., Inc., [Search on Mar. 17, 2015], Internet <URL: http://www.kyuden.co.jp/library/pdf/notice/q27hfv5k.pdf>

[Non-Patent Document 2] Japan Photovoltaic Energy Association, Japan Electrical Manufacturers' Association, Federation of Electric Power Companies of Japan, “Shiryo 2 Shutsuryoku seigyo kino tsuki PCS no gijutsushiyo ni tsuite (Material 2 As for technical specification of PCS with power output control function)”, [online] sheet 8, March 2015, Ministry of Economy, Trade and Industry, Agency for Natural Resources and Energy, Advisory Committee for Natural Resources and Energy, Committee on Energy Efficiency and Renewable Energy, New and Renewable Energy Subcommittee, system working group (5th), distributed material, [Search on Mar. 17, 2015], Internet <URL: http://www.meti.go.jp/committee/sougouenergy/shoene_shinene/shin_ene/keitou_wg/pdf/005_0 2_00.pdf>

### SUMMARY OF THE INVENTION

### Technical Problem

The above-mentioned Patent Document and Non-Patent Documents describe a system including a photovoltaic power generation system and a power storage apparatus, and a power output control method. At the time of surplus purchase, power output control is performed so that the backflow to the power system becomes zero, but since the self-consumption electric power amount is not controlled in principle, and in a case where generated electric power is equal to or more than the self-consumption electric power, there is wasted electric power.

The present invention has been made in view of such circumstances, and an object of the present invention is to provide a charging and discharging control apparatus capable of reducing wasted electric power during execution of power output control a method for controlling the apparatus, and a program.

### Solution to Problem

In each aspect of the present invention, in order to solve the above-mentioned problems, the following configurations are respectively adopted.

A first aspect relates to a charging and discharging control apparatus.

The charging and discharging control apparatus in the first aspect is a charging and discharging control apparatus that controls charging and discharging of a power storage apparatus,

the power storage apparatus being connected to an alternating current (AC) power line, and

the AC power line being connected to a power system, being connected to a direct current (DC) power generation apparatus through a DC/AC conversion apparatus, and being connectable to a load,

the charging and discharging control apparatus including:

an acquisition unit that acquires at least one of a direction and magnitude of electric power flowing between the AC power line and the power system; and

a control unit that controls charging of the power storage apparatus based on a change in at least one of the direction and magnitude of electric power flowing between the AC power line and the power system when a charging amount to the power storage apparatus is increased by a predetermined amount.

A second aspect relates to a control method performed by a charging and discharging control apparatus, which is executed by at least one computer.

The control method performed by the charging and discharging control apparatus in the second aspect is a method of controlling a charging and discharging control apparatus that controls charging and discharging of a power storage apparatus,

the power storage apparatus being connected to an AC power line, and

the AC power line being connected to a power system, being connected to a DC power generation apparatus through a DC/AC conversion apparatus, and being connectable to a load,

the control method performed by the charging and discharging control apparatus including:

acquiring at least one of a direction and magnitude of electric power flowing between the AC power line and the power system; and

controlling charging of the power storage apparatus based on a change in at least one of the direction and magnitude of electric power flowing between the AC power line and the power system when a charging amount to the power storage apparatus is increased by a predetermined amount.

Note that, another aspect of the present invention may be a program causing the at least one computer to execute the method in the second aspect, or may be a computer-readable storage medium storing the program. The storage medium includes a non-transitory tangible medium.

The computer program includes computer program code which, when executed by a computer, causes the computer to execute the control method on the charging and discharging control apparatus.

Note that, those obtained by converting any combination of the foregoing components and the representation of the present invention between a method, an apparatus, a system, a storage medium, a computer program, and the like are also effective as aspects of the present invention.

Various types of components of the present invention are not necessarily required to be present individually and independently, but a plurality of components may be formed as one member, one component may be formed by a plurality of members, a certain component may be a portion of another component, a portion of a certain component and a portion of another component may overlap each other, or the like.

A plurality of procedures are described in order in the method and the computer program according to the present invention, but the order of the description is not intended to limit the order of the execution of the plurality of procedures. Therefore, when the method and the computer program of the present invention are executed, the order of the plurality of procedures may be changed within the range of not causing any problem in terms of the contents.

Further, the plurality of procedures of the method and the computer program according to the present invention are not limited to be individually executed at timings different from each other. Therefore, another procedure may occur during the execution of a certain procedure, the execution timing of a certain procedure and a portion or all of the execution timings of another procedure may overlap each other, or the like.

### Advantageous Effects of Invention

According to each aspect described above, it is possible to provide a charging and discharging control apparatus capable of reducing wasted electric power during execution of power output control, a method for controlling the apparatus, and a program.

### BRIEF DESCRIPTION OF THE DRAWINGS

The object and other objects, and features and advantages described above will become more apparent by preferred example embodiments described below and the following drawings associated therewith.

FIG. 1 is a schematic block diagram illustrating a configuration example of a photovoltaic power generation system.

FIG. 2 is a schematic block diagram illustrating a configuration example of a power storage system according to an example embodiment of the present invention.

FIG. 3 is a functional block diagram logically illustrating a configuration of a charging and discharging control apparatus according to an example embodiment of the present invention.

FIG. 4 is a diagram illustrating an example of the transition of the charge capacity over time by charging and discharging control of the storage battery of the power storage system of the example embodiment.

FIG. 5 is a diagram for explaining charging and discharging control of a storage battery of the power storage system of the example embodiment.

FIG. 6 is a diagram illustrating an example of the configuration of a computer that implements the charging and discharging control apparatus of the example embodiment.

FIG. 7 is a flowchart illustrating an example of operations of the charging and discharging control apparatus according to the example embodiment.

FIG. 8 is a diagram illustrating an example of a data structure of a storage apparatus accessed by the charging and discharging control apparatus of the example embodiment.

FIG. 9 is a flowchart illustrating an example of operations of the charging and discharging control apparatus according to the example embodiment.

FIG. 10 is a diagram for explaining PV surplus electric power and PV power output suppression according to the present invention.

FIG. 11 is a schematic block diagram illustrating a configuration example of a power storage system according to an example embodiment of the present invention.

FIG. 12 is a functional block diagram logically illustrating a configuration of a charging and discharging control apparatus according to an example embodiment of the present invention.

### DESCRIPTION OF EMBODIMENTS

Hereinafter, example embodiments of the present invention will be described with reference to the drawings. In all the drawings, same components are denoted by the same reference numerals, and descriptions thereof will not be repeated.

### First Example Embodiment

A power storage system, a charging and discharging control apparatus, a method of controlling the apparatus, and a program according to a first example embodiment of the present invention will be described below.

The charging and discharging control apparatus of the example embodiment controls charging and discharging of a lithium ion secondary battery.

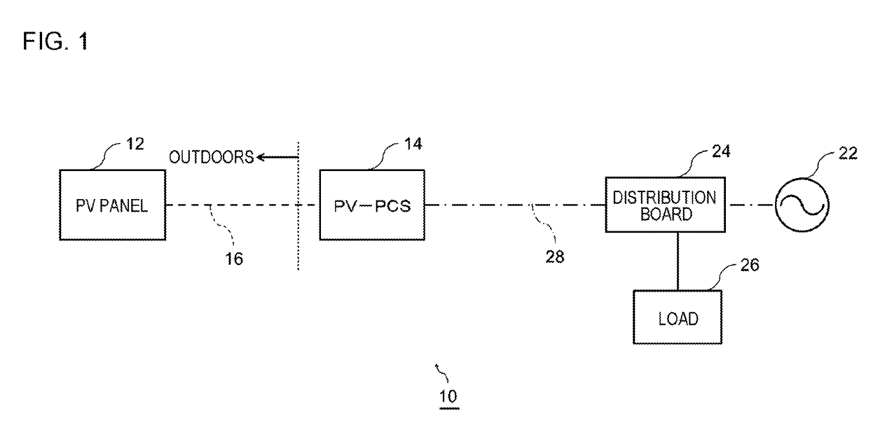

FIG. 1 is a schematic block diagram illustrating a configuration example of a photovoltaic (PV) system 10.

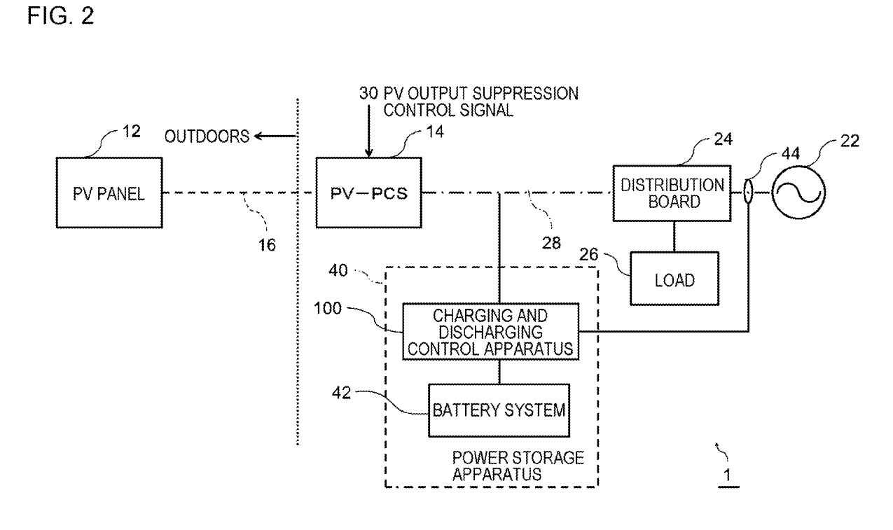

FIG. 2 is a schematic block diagram illustrating a configuration example of the power storage system 1 according to the example embodiment of the present invention. The power storage system 1 illustrates a configuration after a power storage apparatus 40 is added to an AC power line 28 (28a and 28b) side of the existing PV system 10 in FIG. 1.

In each drawing of the present specification, configurations of portions that are not related to the spirit of the invention are not described and not illustrated.

The existing PV system 10 in FIG. 1 includes a PV panel 12, a Power Conditioning System (PV-PCS 14), a distribution board 24, and a load 26. In the example embodiment, it is considered that the PV panel 12 is installed outdoors, and a Photovoltaics Power Conditioning System (PV-PCS) (Photovoltaics power conditioner) 14, the distribution board 24, and the load 26 are installed indoors. This is only illustrative, and there is also a system in which at least one of the PV-PCS 14, the distribution board 24, and the load 26 is installed outdoors.

The PV panel 12 and the PV-PCS 14 are connected by a DC power line 16 (indicated by a broken line).

The PV-PCS 14, the distribution board 24, and a power system 22 are connected by an AC power line 28 (28a and 28b) (indicated by a one-dotted chain line). A load 26 is further connected to the AC power line 28 (28a and 28b) through the distribution board 24.

The PV panel 12 includes a plurality of solar cells that receive solar light energy and convert it into electricity, is protected with tempered glass, acrylic resin, or the like, and is, for example, installed on a roof of a residence.

DC power generated by the PV panel 12 is input to the PV-PCS 14 through the DC power line 16. The PV-PCS 14 has a function of converting the DC power generated by the PV panel 12 into AC power generally used by home appliances (load 26).

In the example embodiment, the PV-PCS 14 also has a function of controlling the operation of the PV panel 12. For example, the PV-PCS 14 receives a power output suppression control signal 30 (hereinafter, also referred to as a PV power output suppression signal) for the PV panel 12, and suppresses the output of the PV panel 12 according to the control signal. The PV power output suppression signal 30 includes, for example, an instruction to suppress output to a predetermined ratio (%) of the rated power output of the PV-PCS 14.

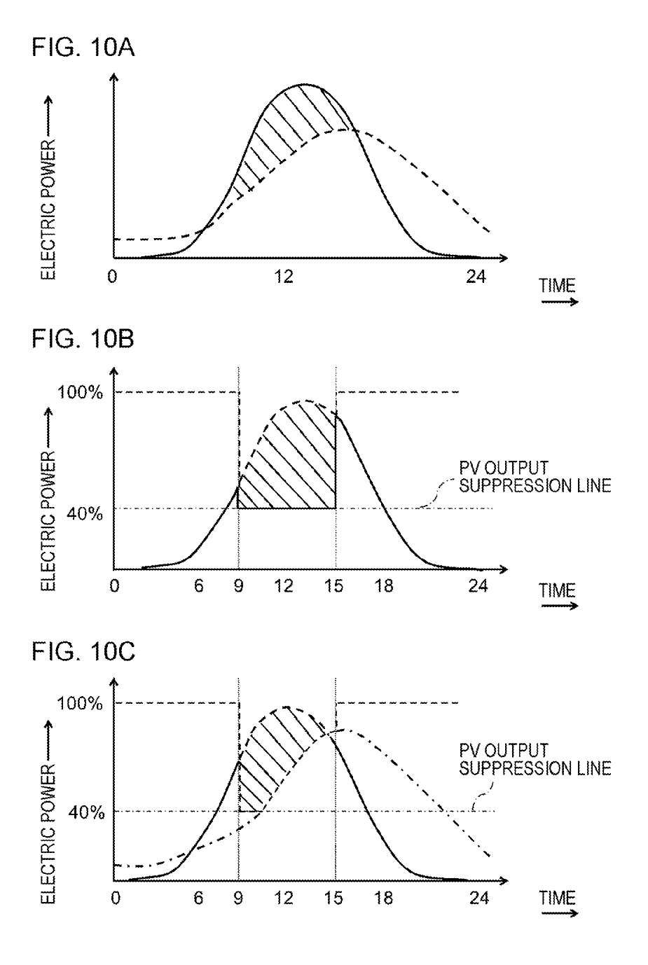

An upper limit of the electric power amount of the PV power output is set by the PV power output suppression signal 30. As illustrated in FIG. 10A, a difference portion (hatched portion) between the power generation amount (solid line) of the PV panel 12 and the consumption electric power amount (broken line) of the load 26 is surplus electric power of the PV panel 12. Surplus electric power may be efficiently used for charging the storage battery without being wasted.

As illustrated in FIG. 10B, in the case of full amount purchase, when the suppression control of the power generation amount is performed by the PV power output suppression signal 30, the power generation amount of the PV panel 12 (electric power output from the PV-PCS 14) is suppressed to a PV power output suppression line.

Further, as illustrated in FIG. 10C, in the case of surplus purchase, when the suppression control of the power generation amount is performed by the PV power output suppression signal 30, electric power output from the PV-PCS 14 is suppressed to the PV power output suppression line or the power generation amount to be the same as the self-consumption electric power amount (the backflow to the power system becomes zero). In this case, electric power exceeding the PV power output suppression line and the self electric power consumption is not output from the PV-PCS 14 and cannot be used.

Therefore, in the present invention, electric power that is suppressed by this PV power output suppression control is efficiently charged to the storage battery and used in the storage battery.

The load 26 is at least one of various pieces of electrical equipment such as an air conditioner, a lighting apparatus, a refrigerator, a television, a microwave oven, a hairdryer, a personal computer, a game machine, a telephone, a water heater, an electric car, and a plugin hybrid electric vehicle, and is not particularly limited thereto.

Electricity is supplied from the power system 22 to the distribution board 24 of the customer's house through a power transmission network, and electricity is distributed to each load 26 through the distribution board 24.

The DC power generated by the PV panel 12 is input to the PV-PCS 14 through the DC power line 16, is converted into AC power, and is output to the AC power line 28a. It passes through the AC power line 28a and may be supplied to the load 26 through the distribution board 24.

The electric power generated by the PV panel 12 may be consumed by the consumer's load 26 and a surplus of the electric power may also flow back to the power system 22 through the distribution board 24. However, in the example embodiment, the surplus electric power generated by the PV panel 12 is charged to the lithium ion secondary battery of a battery system 42 in the power storage apparatus 40 as much as possible without flowing back to the power system 22.

As illustrated in FIG. 2, the power storage system 1 of the example embodiment includes the power storage apparatus 40 and a clamp type AC sensor 44.

A charging and discharging control apparatus 100 of the example embodiment controls charging and discharging of the battery system 42 connected to the PV system 10. The power storage apparatus 40 of the example embodiment includes the battery system 42 and the charging and discharging control apparatus 100. The power storage apparatus 40 is electrically connected to the AC power line 28a between the PV-PCS 14 and the distribution board 24. The power storage apparatus 40 in the example embodiment is installed indoors but may also be installed outdoors.

Note that in the example embodiment, the PV system 10 is described as an example, the present invention is not limited to photovoltaics, but may be also applied to other systems of renewable energy power generation that outputs DC power.

The battery system 42 includes at least one lithium ion rechargeable secondary battery (lithium-ion rechargeable battery) (hereinafter, also referred to as a “storage battery”) (not illustrated) and a Battery Management Unit (BMU) that manages the lithium ion secondary battery. The battery system 42 has an electric capacity chargeable by the system, as indicated by the rated capacity (kWh). The battery system 42 is controlled by the charging and discharging control apparatus 100 in charging and discharging of the storage battery.

In the example embodiment, although the detailed description thereof is not described, charging and discharging control is performed within a predetermined range with respect to a rated capacity of the storage battery in charging and discharging control of the storage battery.

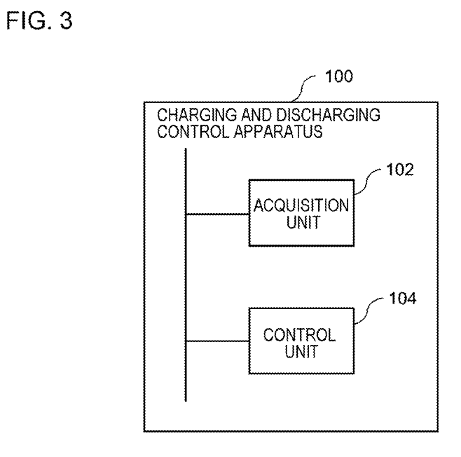

FIG. 3 is a functional block diagram logically illustrating the configuration of the charging and discharging control apparatus 100 according to the example embodiment of the present invention. Hereinafter, the configuration of the charging and discharging control apparatus 100 of the example embodiment will be described with reference to FIG. 2 and FIG. 3.

The charging and discharging control apparatus 100 includes an acquisition unit 102 that acquires at least one of a direction and magnitude of electric power flowing between an AC power line 28b and power system 22, and a control unit 104 that controls charging of the power storage apparatus 40 based on a change in at least one of the direction and magnitude of electric power flowing between an AC power line 28b and power system 22 when a charging amount to the power storage apparatus 40 is increased by a predetermined amount.

In the present specification, “acquisition” includes at least one of: the own apparatus acquiring data or information stored in another apparatus or a storage medium (active acquisition), for example, receiving data or information by making a request or inquiry into another apparatus, or reading out data or information by having access to another apparatus or a storage medium, or the like; and inputting data or information output from another apparatus to the own apparatus (passive acquisition), for example, receiving distributed (or transmitted, push notified, and the like) data or information, or the like. The “acquisition” also includes selecting and acquiring from among the received data or information, or selecting and receiving the distributed data or information.

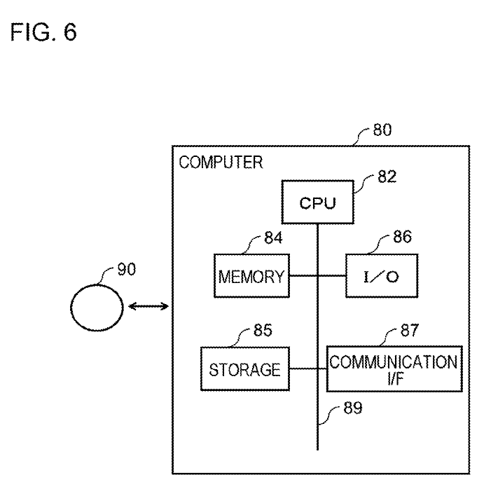

The charging and discharging control apparatus 100 of the example embodiment may further be accessibly connected to a storage apparatus 110 (not illustrated). The storage apparatus 110 may be included in the charging and discharging control apparatus 100 or may be an external apparatus of the charging and discharging control apparatus 100. In the example embodiment, the storage apparatus 110 may be implemented by a memory 84 or storage 85 of a computer 80 in FIG. 6 to be described later.

Hereinafter, each component of the charging and discharging control apparatus 100 in FIG. 3 will be described in detail.

The acquisition unit 102 acquires information on at least one of a magnitude and direction of a current flowing between the AC power line 28b and the power system 22. In the example of FIG. 2, for example, the clamp type AC sensor, that is, a Current Transformer (CT) 44 of FIG. 2 is attached to the AC power line 28b between the distribution board 24 and the power system 22, and the current value of the AC power line 28b is measured by the clamp type AC sensor 44 The acquisition unit 102 acquires the current value measured by the clamp type AC sensor 44 and acquires information on at least one of the magnitude and direction of the current.

As described above, the control unit 104 determines whether or not to charge the power storage apparatus (battery system 42) based on the magnitude or direction of the current in the AC power line 28b, and controls charging and discharging of the power storage apparatus (battery system 42).

In detail, the control unit 104 performs control to charge a surplus (surplus electric power) remaining without being consumed by the load 26 out of electric power generated by the PV panel 12, to the power storage apparatus (storage battery of the battery system 42).

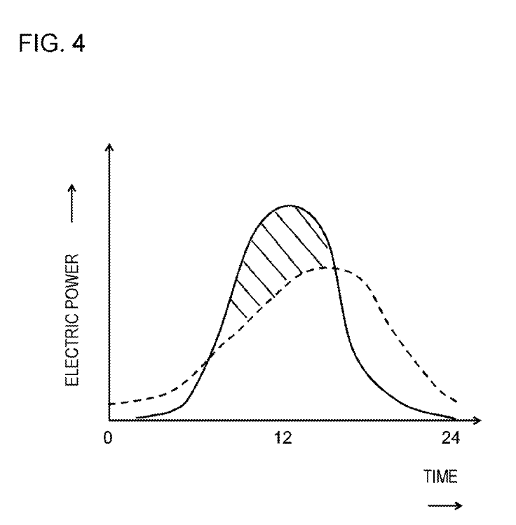

As illustrated in FIG. 4, a difference (hatched portion) between the power generation amount (indicated by a solid line) of the PV panel 12 at each time and a consumption amount (indicated by a broken line) of the electric power of the load 26 is the surplus electric power of the PV panel 12.

The control unit 104 may perform control of discharging the storage battery.

For example, instead of the electric power supplied from the power system 22 or the PV panel 12 to the load 26, the electric power charged to the storage battery may be discharged from the storage battery and supplied to the load 26.

In the example embodiment, it is considered that the electric power discharged from the storage battery is not caused to flow back to the power system 22 and is consumed by the load 26 of the customer.

In the example embodiment, the acquisition unit 102 acquires information on at least one of the direction and magnitude of the current flowing through the AC power line 28b, and the control unit 104 controls the charging and discharging of the storage battery based on the information. However, the present invention is not limited thereto. As described below, configurations for performing charging and discharging control of the storage battery under various information or conditions are also not eliminated. A plurality of the followings may be combined without contradiction.

In the present invention, based on information indicating whether there is surplus in the electric power generated by the PV panel 12, it is possible to determine whether charging is possible or not.

The conditions for the control unit to determine whether charging is possible or not are exemplified below.

(a1) Charging is performed when the direction of the current in the AC power line 28b is from the distribution board 24 to the power system 22, that is, in a case where a backflow (electricity sale) to the power system 22 is generated.

(a2) Charging is performed using surplus exceeding a threshold value, in a case where the power generation amount from the PV panel 12 is equal to or larger than the threshold value.

(a3) Charging is performed using surplus electric power controlled to be suppressed in output by the PV power output suppression signal 30.

(a3) is the control according to the present invention. The conditions in (a1) and (a2) are for controlling the electricity sale to be zero or to be reduced. In the present invention, since the electricity sale need not be zero, the conditions of (a1) and (a2) may or may not be used.

Further, the control unit may control charging and discharging of the storage battery by using at least one of the plurality of conditions (b1) to (b5) as illustrated below in combination.

(b1) Charging and discharging is performed according to a predetermined first time zone in which the storage battery may be charged and a second time zone in which the storage battery may be discharged.

In this configuration, information on the first time zone and the second time zone is stored in the storage apparatus 110 in advance.

In the power storage apparatus 40 of the example embodiment, it is considered that the first time zone in which the storage battery may be charged, and the second time zone in which the storage battery may be discharged, are determined in advance. The first time zone is set from 6 o'clock to 18 o'clock and the second time zone is set from 18 o'clock to 6 o'clock on the next day.

It is considered that the charging and discharging control apparatus 100 has a clock (not illustrated) and acquires time information from the clock. The clock need not be included in the charging and discharging control apparatus 100 or may be an external apparatus of the charging and discharging control apparatus 100.

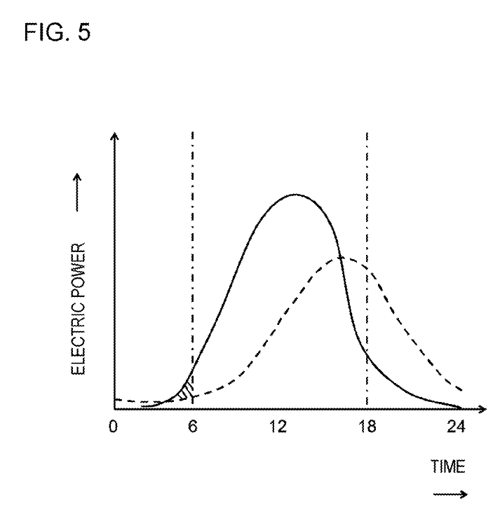

As illustrated in FIG. 5, even if the power generation amount of the PV panel 12, indicated by the solid line, exceeds a power consumption amount of the load 26 indicated by the broken line, surplus electric power (indicated by hatching in the figure) in the second time zone is not charged to the storage battery.

(b2) In a case where the storage battery is fully charged, charging is not performed.

In this configuration, the acquisition unit 102 may acquire information indicating that the storage battery is fully charged from the BMU of the battery system 42.

(b3) When the storage battery is charged to a predetermined ratio (%) or more of the storage capacity, charging is stopped. In the second time zone, discharging from the storage battery is permitted.

In this configuration, a predetermined ratio (%) of the storage capacity of the storage battery is stored in the storage apparatus 110 in advance.

(b4) Control of charging and discharging of the storage battery is performed according to a situation of electricity purchase or electricity sale in the power system 22.

This configuration will be described in detail in an example embodiment as follows.

(b5) When a remaining power storage capacity of the storage battery is smaller than the first threshold value or an available capacity is equal to or larger than the second threshold value, discharge of the storage battery is stopped.

In this configuration, the acquisition unit 102 may acquire the information on the remaining power storage capacity or the available capacity of the storage battery from the BMU of the battery system 42. The threshold values are stored in the storage apparatus 110 in advance. Each threshold value may have a configuration to be updatable from the outside.

FIG. 6 is a diagram illustrating an example of a configuration of a computer 80 that implements the charging and discharging control apparatus 100 of the example embodiment.

The computer 80 of the present embodiment includes a Central Processing Unit (CPU) 82, a memory 84, a program 90 that implements the components of the charging and discharging control apparatus 100 loaded in the memory 84, a storage 85 that stores the program 90, an input/output (I/O) 86, and a network connection interface (communication I/F 87).

The CPU 82, the memory 84, the storage 85, the I/O 86, and the communication I/F 87 are connected with one another through a bus 89, and the whole charging and discharging control apparatus 100 is controlled by the CPU 82. However, a method of connecting the CPU 82 and the like with one another is not limited to bus connection.

The memory 84 is a memory such as a Random Access Memory (RAM) or a Read Only Memory (ROM). The storage 85 is a storage apparatus such as a hard disk, a Solid State Drive (SSD), or a memory card.

The storage 85 may be a memory such as a RAM or a ROM. The storage 85 may be provided inside the computer 80, or provided outside the computer 80 and wired or wirelessly connected to the computer 80 as long as the storage 85 is accessible to the computer 80. Alternatively, the storage 85 may be attachable and detachable to the computer 80.

By reading out and executing the program 90 stored in the storage 85 to the memory 84, the CPU 82 may implement each function of each unit of the charging and discharging control apparatus 100.

The I/O 86 performs input/output control of data and control signals between the computer 80 and other input/output apparatuses. The other input/output apparatuses include, for example, an input apparatus (not illustrated) such as a keyboard, a touch panel, a mouse and a microphone connected to the computer 80, an output apparatus (not illustrated) such as a display, a printer and a speaker, and an interface between these input/output apparatuses and the computer 80. Further, the I/O 86 may perform input/output control of data with a reading or writing apparatus (not illustrated) of another storage medium.

The communication I/F 87 is a network connection interface for performing communication between the computer 80 and an external apparatus. The communication I/F 87 is not necessarily required. The communication I/F 87 may be a network interface for connection to a wired line or network interface for connection to a wireless line. For example, the computer 80 that implements the charging and discharging control apparatus 100 may be connected to a HEMS through a network 3 using the communication I/F 87.

Each component of the charging and discharging control apparatus 100 of the example embodiment is implemented by any combination of hardware and software of the computer 80 in FIG. 6. It is understood by those skilled in the art that there are various modification examples to the implemented method and apparatus. As described below, a functional block diagram illustrating the charging and discharging control apparatus of each example embodiment indicates not configurations of hardware unit, but blocks of logical functional unit.

The charging and discharging control apparatus 100 does not eliminate a configuration including a plurality of computers 80.

The computer program 90 according to the example embodiment causes the computer 80 for implementing the charging and discharging control apparatus 100 to execute a procedure of acquiring at least one of a direction and magnitude of electric power flowing between an AC power line 28b and power system 22, and a procedure of controlling charging of the power storage apparatus 40 based on a change in at least one of the direction and magnitude of electric power flowing between an AC power line 28b and power system 22 when a charging amount to the power storage apparatus 40 is increased by a predetermined amount.

The computer program 90 of the example embodiment may be stored in a storage medium readable by the computer 80. The storage medium is not particularly limited thereto, and various forms of recording media are conceivable. The program 90 may be loaded from the storage medium into the memory 84 of the computer 80, or may be downloaded to the computer 80 through the network and loaded into the memory 84.

The storage medium for storing the computer program 90 includes a medium usable by the non-transitory tangible computer 80, and program codes readable by the computer 80 are embedded in the medium. When the computer program 90 is executed on the computer 80, the computer program 90 causes the computer 80 to execute the following control method that implements the charging and discharging control apparatus 100.

The method of controlling the charging and discharging control apparatus 100 having such a configuration of the example embodiment will be described below.

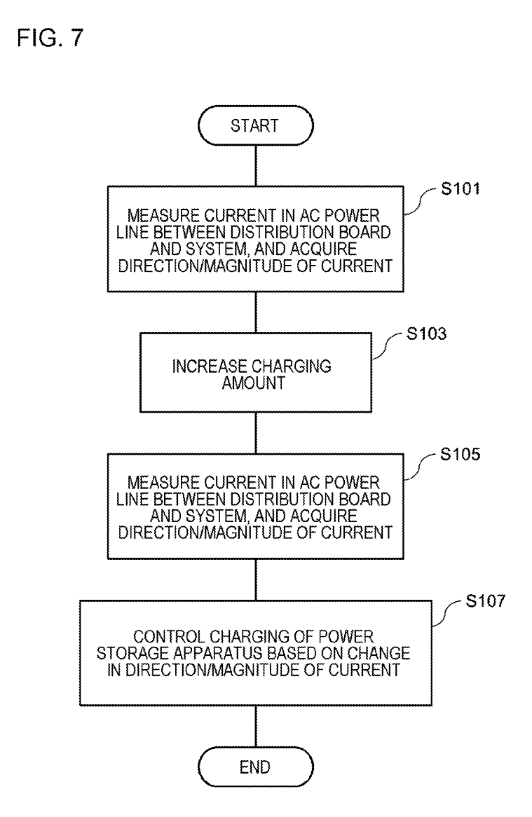

FIG. 7 is a flowchart illustrating an example of operations of the charging and discharging control apparatus 100 according to the example embodiment.

The control method according to the example embodiment of the present invention is a method of controlling the charging and discharging control apparatus 100, and is a control method executed by the computer 80, that implements the charging and discharging control apparatus 100.

The control method according to the example embodiment includes, by the charging and discharging control apparatus 100, acquiring at least one of a direction and the magnitude of electric power flowing between the AC power line 28b and the power system 22 (step S101), and controlling charging of the power storage apparatus 40 (step S107) based on a change in at least one of the direction and magnitude of electric power flowing between the AC power line 28b and the power system 22 (S105) when a charging amount to the power storage apparatus 40 is increased by a predetermined amount (step S103).

Hereinafter, this will be described in more detail.

First, the acquisition unit 102 acquires information on at least one of the direction and magnitude of the current flowing through the AC power line 28b between the distribution board 24 and the power system 22, from the clamp type AC sensor 44 (step S101). The acquired information on the direction or magnitude of the current may be stored in the storage apparatus 110 as a value before the charging amount is changed.

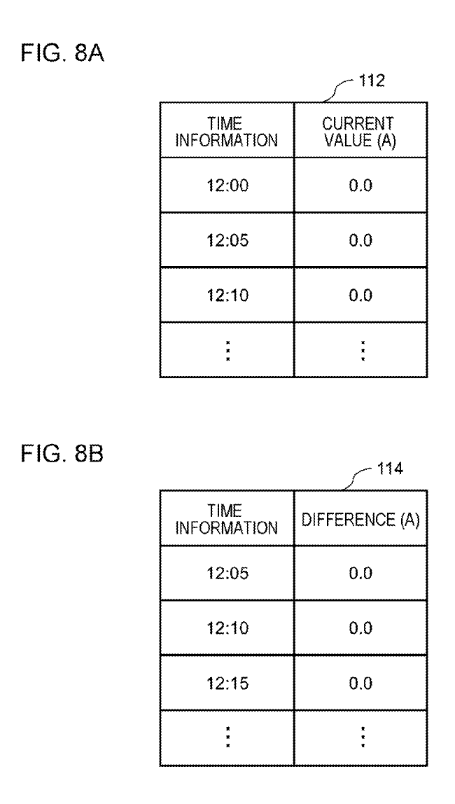

FIG. 8 is a diagram illustrating an example of the data structure of the storage apparatus 110 of the example embodiment.

Specifically, the storage apparatus 110 stores a value of a system current flowing through the AC power line 28b together with time information as current value information 112 (FIG. 8A). Further, as described later, a change between the current before the charging amount is changed and the current after the charging amount is changed, is obtained as a difference of the current value and stored as difference information 114 in the storage apparatus 110 (FIG. 8B). In this example, the difference value is stored in association with the time information of the current value information 112, but this is only illustrative, and the present invention is not limited thereto. For example, the current value information 112 and the difference information 114 may each be stored in the same record in association with the time information.

Herein, it is considered that when the current is flowing in a direction from the power system 22 to the distribution board 24, the current value is a positive value, and when a current is flowing in a direction from the distribution board 24 to the power system 22, the current value is a negative value. Here, since, in the case of an alternating current, the direction of the current changes with time, the current value is positive when an alternating current is zero degrees plus or minus 90 with respect to a phase of an AC voltage, that is, in the case where AC power is output in a direction from the power system 22 to the distribution board 24. On the other hand, the current value is negative when the alternating current is zero degrees plus or minus 90 or more, that is, in a case where AC power is output in a direction from the distribution board 24 to the power system 22.

The control unit 104 increases the charging amount to the power storage apparatus 40 by a predetermined value and performs charging (step S103). Here, the incremented amount of the charging amount may be, for example, a value of more than zero and equal to or less than +1 A. The incremented amount of the charging amount may be appropriately determined according to the rating of the power storage apparatus 40, the PV panel 12 and the PV-PCS 14, the performance of the PV-PCS 14, the measurement accuracy of the clamp type AC sensor 44, and the like.

The acquisition unit 102 again acquires information on at least one of the direction and magnitude of the current flowing through the AC power line 28b between the distribution board 24 and the power system 22, from the clamp type AC sensor 44 (step S105).

After the charging amount is changed, by variation of the load 26 or an increase or decrease in electric power supplied from the PV panel 12 to the PV-PCS 14, the PV-PCS 14 performs processing of changing an amount suppressed by the PV power output suppression control. It takes time to stabilize the electric power at a value designated by the PV power output suppression signal 30. It is preferable that the timing of the measurement of the current value by the acquisition unit 102 is set to a time interval necessary for the electric power to be stabilized after the charging amount is changed.

The acquired information on the direction or magnitude of the current may be stored in the storage apparatus 110 as a value after change in the charging amount.

The control unit 104 obtains a change between the direction or magnitude of the current before the charging amount is changed and the direction or magnitude of the current after the charging amount is changed, and controls charging of the power storage apparatus 40 based on the change (step S107).

First, in the example embodiment, it is possible to operate in a situation where the PV power output suppression signal 30 is received and electricity sale (a direction from the distribution board 24 to the power system 22) is not being performed. Here, in a case where the PV power output suppression signal 30 is received, the current value of the AC power line 28b before the charging amount is changed is zero, or the current flows in a direction of electricity purchase (a direction from the power system 22 to the distribution board 24).

Then, in a case where charging of the power storage apparatus 40 is performed by increasing the charging amount by a predetermined value, the current value of the AC power line 28b is kept at zero, or the direction of the current is not changed after the charging amount is changed and an amount of electricity purchase increases.

Accordingly, when there is no change in a direction or magnitude of the current, the control unit 104 determines that the power generation amount of the PV panel 12 is suppressed by the PV power output suppression control, and performs charging of the power storage apparatus 40 with an output-suppressed amount of electric power.

At this time, the electric power generated by the PV panel 12 flows from the PV panel 12 to the power storage apparatus 40 through the PV-PCS 14 and the AC power line 28a, and is charged to the storage battery of the battery system 42.

On the other hand, in a case where the PV power output suppression signal 30 is not received, the direction or magnitude of the current in the AC power line 28b before the direction of the charging amount may be any one of electricity purchase (power system 22->distribution board 24) (current value >0), electricity sale (distribution board 24->power system 22) (current value <0), or current value of zero.

In a case where charging of the power storage apparatus 40 is performed by increasing the charging amount by an amount to be charged, the current amount of the current in the AC power line 28b after the charging amount is changed, increases at the time of electricity purchase and decreases at the time of electricity sale, and when the current value is zero, the current increases in the direction of electricity purchase.

In the example embodiment, in a case where the PV power output suppression signal 30 is received and the power generation amount of the PV panel 12 is suppressed, the power storage apparatus 40 is charged with a suppressed amount of electric power, but in other cases, the charging amount to the power storage apparatus 40 is not changed by this processing.

The processing of the flowchart in FIG. 7 may be repeatedly executed at a predetermined cycle, for example, during the first time zone in which the storage battery may be charged. The processing of each step may be performed asynchronously.

As described above, in the charging and discharging control apparatus 100 of the example embodiment, the acquisition unit 102 acquires the direction or magnitude of the current in the AC power line 28b, and the control unit 104 controls charging of the storage battery of the battery system 42 based on a change in the direction or magnitude of the current in the AC power line 28b when the charging amount to the power storage apparatus 40 is increased.

As described above, according to the charging and discharging control apparatus 100 of the example embodiment, in particular, in a case where the PV power output suppression control is applied, with a simple configuration, it is possible to efficiently charge the storage battery of the battery system 42 with the suppressed amount of electric power.

### Second Example Embodiment

Next, the power storage system according to a second example embodiment of the present invention will be described below.

The power storage system of the example embodiment has the same configuration as that of the power storage system 1 of the aforementioned example embodiment in FIG. 2, and will be described below with reference to FIG. 2 and FIG. 3.

In the example embodiment, an example of a method of controlling charging and discharging a storage battery in the control unit 104 of the aforementioned example embodiment will be described in detail.

A specific control method will be described below.

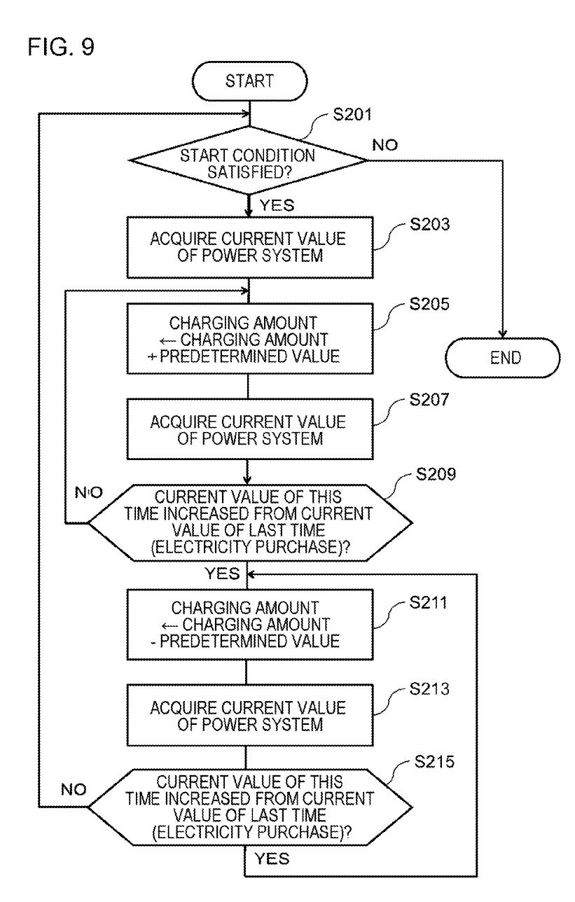

FIG. 9 is a flowchart illustrating an example of operations of the charging and discharging control apparatus 100 according to the example embodiment.

Herein, it is considered that the current flowing through the AC power line 28b, acquired by the acquisition unit 102, takes a negative value when the current is flowing in the direction from the distribution board 24 to the power system 22, and takes a positive value when the current is flowing in the direction from the power system 22 to the distribution board 24.

The predetermined value for increasing or decreasing the charging amount in the following procedures is set to plus or minus 1 A, but is not limited thereto. This may be determined according to the rating of the power storage apparatus 40, the PV panel 12, and the PV-PCS 14, the measurement accuracy of the clamp type AC sensor 44, the performance of the PV-PCS 14, and the like. The predetermined value may be stored in advance in the storage apparatus 110 or may be adjustable by the customer.

This processing routine is started when at least one or all of the following conditions (c1) to (c5) are satisfied. In a case where the processing routine is being executed, when at least one of the following conditions is not satisfied, charging of the storage battery may be stopped and this processing routine may be ended.

(c1) The storage battery is not fully charged.

Based on information indicating the charged state of the storage battery (whether or not the storage battery is fully charged or not) acquired by the acquisition unit 102, it is determined whether the storage battery is fully charged or not.

(c2) The current value (electricity purchase) of electric current supplied in the direction from the power system 22 to the AC power line 28b is within a predetermined range. Strictly speaking, the current value is zero or in a state of electricity purchase, but since there are some errors, it is conditional that the current value (electricity purchase) is in the predetermined range.

For example, the acquisition unit 102 acquires the current value of the AC power line 28b measured by the clamp type AC sensor 44, and determines whether the current value is within a predetermined range that is equal to or more than −1 A and equal to or less than +1 A, in consideration of an error range.

(c3) A current (electricity sale) is flowing from the AC power line 28b to the power system 22.

(c4) The time is in a chargeable time zone.

(c5) Information indicating that PV power output suppression is being performed is acquired.

For example, this processing routine may be started when the conditions (c1) and (c5) are satisfied, that is, when information indicating that the storage battery is not fully charged and the PV power output suppression is being performed is acquired. In the case where this processing routine is being executed, the present processing routine may be ended when the condition of (c1) is no longer satisfied, that is, when the storage battery is fully charged. This is only illustrative, and the start and end of this processing routine may be determined in combination with other conditions.

First, when at least one or all of the start conditions of this processing routine is satisfied (“YES” in step S201), this processing is started.

The acquisition unit 102 acquires the current value on a power system 22 side of the AC power line 28b (step S203). The acquired current value is stored in the storage apparatus 110 as a current value before the charging amount is changed.

The charging amount to the storage battery is increased by a predetermined value (step S205).

Thereafter, the acquisition unit 102 again acquires the current value of the AC power line 28b on the power system 22 side (step S203). The acquired current value is stored in the storage apparatus 110 as a current value after the charging amount is changed.

The control unit 104 determines whether the current value (this time) after the charging amount is changed has increased from the current value (last time) before the charging amount is changed or whether there is no change therebetween (step S209). In a case where the current value of this time has increased from the current value of last time (“YES” in step S209), it is determined that the PV power output suppression control is not performed, and the increased charging amount in step S205 is returned to an original value (step S211).

On the other hand, in a case where there is no change between the current values of last time and this time (“NO” in step S209), it is determined that PV power output suppression control is being performed, and the processing returns to step S205 to further increase the charging amount.

When the charging amount is increased by the predetermined value in step S205, the surplus electric power of the PV panel 12, which is suppressed by the PV power output suppression control, may be used for charging the storage battery.

When the charging amount reaches the surplus electric power amount, the current value begins to decrease (turning to electricity purchase) (“YES” in step S209).

Accordingly, the increased charging amount in step S205 is returned to the original value (step S211).

Further, in a case where the output of the PV panel 12 decreases and electricity purchase increases, the charging amount is decreased by a predetermined value (step S211), and the current value of the AC power line 28b is acquired (step S213). Then, steps S211 to S215 are repeated until there is no electricity purchase in view of the current values of this time and last time (“YES” in step S215). When there is no electricity purchase (“NO” in step S215), the processing returns to step S201.

Note that, in step S201, this processing routine may be performed asynchronously, and an instruction to stop the processing routine may be issued when the condition is no longer satisfied. In this processing routine, a procedure of stopping may be executed and this processing may be ended.

As described above, in the charging and discharging control apparatus 100 of the example embodiment, the control unit 104 performs charging and discharging control of the power storage apparatus 40 according to an increase or decrease in a current amount of a current output from the DC power line 16 to the DC/AC conversion apparatus (PV-PCS 14) when a charging amount to the power storage apparatus 40 is increased by a predetermined amount.

As a result, according to the charging and discharging control apparatus 100 of the example embodiment, in the case where the surplus electric power of the PV panel 12 is suppressed by the PV power output suppression control, it is possible to charge the storage battery with the suppressed surplus electric power so that the electric power may be utilized without being wasted.

As described above, although the example embodiments of the present invention have been described with reference to the drawings, they are an example of the present invention, and various configurations may be adopted in addition to those as described above.

For example, in the aforementioned example embodiments, there has been described an example in which the DC power generation apparatus is a photovoltaic power generation facility and the conversion apparatus is a Photovoltaics Power Conditioning System (PV-PCS) (Photovoltaics power conditioner).

The DC power generation apparatus may include at least one of a photovoltaic power generation facility, a fuel cell, and a private power generation facility utilizing fossil energy.

In the example embodiment, the current value of the AC power line 28b between the power system 22 and the distribution board 24 is acquired to determine whether PV power output suppression control is being applied or not. However, in other example embodiments, the determination may be made by acquiring the current value of the DC power line 16.

The control unit 104 of the charging and discharging control apparatus 100 of the example embodiment performs charging and discharging control of the power storage apparatus 40 according to the increase or decrease in a current amount of the current output from the DC power line 16 to the DC/AC conversion apparatus (PV-PCS 14) when the charging amount to the power storage apparatus 40 is increased by the predetermined amount.

For example, when PV power output is suppressed, control is performed so as to follow the power consumption amount of the load 26 without electricity sale to the power system 22. Under this condition, when the charging amount is increased, a current of an output unit of the PV panel 12 is also increased. The determination may be performed by monitoring the current of the output unit of the PV panel.

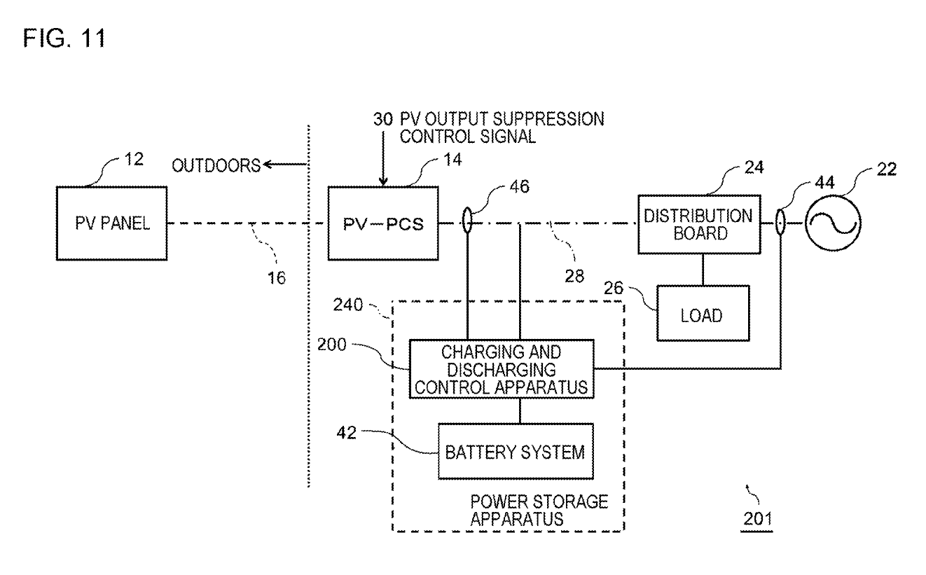

In the aforementioned example embodiment, an example of performing the determination in view of electricity purchase from the system is illustrated, but as illustrated in FIG. 11, more accurate control becomes possible by performing determination using electric power output from the PV-PCS 14 after the charging amount is changed, which is measured by a current sensor 46.

That is, the power storage system 201 of the example embodiment includes a power storage apparatus 240, the clamp type AC sensor 44, and the current sensor 46.

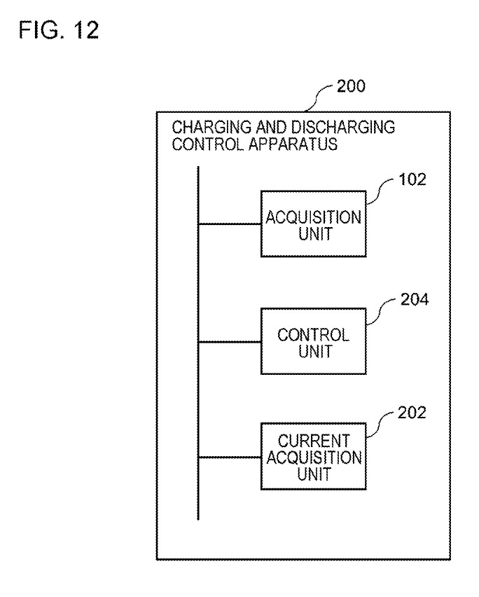

The power storage apparatus 240 includes a charging and discharging control apparatus 200 and a battery system 42. As illustrated in FIG. 12, the charging and discharging control apparatus 200 includes an acquisition unit 102, a control unit 204, and a current acquisition unit 202. The acquisition unit 102 is similar to the aforementioned example embodiment.

Specifically, the control unit 204 of the charging and discharging control apparatus 200 changes the charging amount based on the direction and magnitude of the current flowing through the AC power line 28b, which are measured by the clamp type AC sensor 44.

Further, the current acquisition unit 202 acquires electric power from the PV-PCS 14 after the charging amount is changed, which is measured by the current sensor 46.

When the electric power from the PV-PCS 14 increases after the charging amount is changed, the control unit 204 determines that suppression is being performed. On the other hand, when there is no change in the electric power from the PV-PCS 14 after the charging amount is changed, the control unit 204 determines that the PV-PCS 14 is operated at the rated power output.

According to this configuration, it is possible to improve the accuracy of determination that PV suppression is being performed.

While the present invention has been particularly shown and described with reference to the example embodiments and examples thereof, the present invention is not limited thereto. It will be understood by those of ordinary skill in the art that various changes in configuration and details may be made therein without departing from the scope of the present invention.

Note that, when information on the user is obtained and utilized in the present invention, the obtaining and the utilizing are to be lawfully performed.

Hereinafter, examples of a reference embodiment will be supplementally described.

1. A control method performed by a charging and discharging control apparatus that controls charging and discharging of a power storage apparatus,

the power storage apparatus being connected to an AC power line, and

the AC power line being connected to a power system, being connected to a DC power generation apparatus through a DC/AC conversion apparatus, and being connectable to a load,

the control method performed by the charging and discharging control apparatus including:

acquiring at least one of a direction and magnitude of electric power flowing between the AC power line and the power system; and

controlling charging of the power storage apparatus based on a change in at least one of the direction and magnitude of electric power flowing between the AC power line and the power system when a charging amount to the power storage apparatus is increased by a predetermined amount.

2. The control method performed by the charging and discharging control apparatus according to 1, further including

performing charging control of the power storage apparatus based on a presence or absence of an instruction to suppress output of the DC power generation apparatus.

3. The control method performed by the charging and discharging control apparatus according to 1 or 2, further including

performing charging control of the power storage apparatus when a current value of electric current supplied in a direction from the power system to the AC power line is within a predetermined range.

4. The control method performed by the charging and discharging control apparatus according to any one of 1 to 3, further including

performing charging control of the power storage apparatus according to an increase or decrease in the current amount of the current output from the DC power line to the DC/AC conversion apparatus when the charging amount to the power storage apparatus is increased by a predetermined amount.

5. The control method performed by the charging and discharging control apparatus according to any one of 1 to 4, further including:

acquiring a magnitude of a current output from the DC/AC conversion apparatus to the AC power line; and

performing charging control of the power storage apparatus based on the magnitude of the current output from the DC/AC conversion apparatus.

6. The control method performed by the charging and discharging control apparatus according to any one of 1 to 5, in which the DC power generation apparatus includes at least one of a photovoltaic power generation facility, a fuel cell, and a private power generation facility utilizing fossil energy.

7. The control method performed by the charging and discharging control apparatus according to any one of 1 to 6,

in which the DC power generation apparatus is a photovoltaic power generation facility, and

the DC/AC conversion apparatus is a Photovoltaics Power Conditioning System (PV-PCS) (Photovoltaics power conditioner).

8. A program of a computer for implementing a charging and discharging control apparatus that controls charging and discharging of a power storage apparatus,

the power storage apparatus being connected to an AC power line, and

the AC power line being connected to a power system, being connected to a DC power generation apparatus through a DC/AC conversion apparatus, and being connectable to a load,

the program causing the computer to execute:

a procedure of acquiring at least one of a direction and magnitude of electric power flowing between the AC power line and the power system; and

a procedure of controlling charging of the power storage apparatus based on a change in at least one of the direction and magnitude of electric power flowing between the AC power line and the power system when a charging amount to the power storage apparatus is increased by a predetermined amount.

9. The program according to 8, causing the computer to further execute:

a procedure of performing charging control of the power storage apparatus based on the presence or absence of an instruction to suppress output of the DC power generation apparatus.

10. The program according to 8 or 9, causing the computer to further execute:

a procedure of performing charging control of the power storage apparatus when a current value of electric current supplied in a direction from the power system to the AC power line is within a predetermined range.

11. The program according to any one of 8 to 10, causing the computer to further execute:

a procedure of performing charging control of the power storage apparatus according to an increase or decrease in the current amount of the current output from the DC power line to the DC/AC conversion apparatus when the charging amount to the power storage apparatus is increased by a predetermined amount.

12. The program according to any one of 8 to 11, causing the computer to further execute:

a procedure of acquiring a magnitude of a current output from the DC/AC conversion apparatus to the AC power line; and

a procedure of performing charging control of the power storage apparatus based on the magnitude of the current output from the DC/AC conversion apparatus.

13. The program according to any one of 8 to 12, in which the DC power generation apparatus includes at least one of a photovoltaic power generation facility, a fuel cell, and a private power generation facility utilizing fossil energy.

14. The program according to any one of 8 to 13,

in which the DC power generation apparatus is a photovoltaic power generation facility, and

the DC/AC conversion apparatus is a Photovoltaics Power Conditioning System (PV-PCS) (Photovoltaics power conditioner).

15. A charging and discharging control apparatus which controls charging and discharging of a power storage apparatus,

the power storage apparatus being connected to an AC power line, and

the AC power line being connected to a power system, being connected to a DC power generation apparatus through a DC/AC conversion apparatus, and being connectable to a load,

the charging and discharging control apparatus including:

an acquisition unit that acquires at least one of a direction and magnitude of electric power flowing between the AC power line and the power system; and

a control unit that controls charging of the power storage apparatus based on a change in at least one of the direction and magnitude of electric power flowing between the AC power line and the power system when a charging amount to the power storage apparatus is increased by a predetermined amount.

16. The charging and discharging control apparatus according to 15, in which the control unit performs charging control of the power storage apparatus based on a presence or absence of an instruction to suppress output of the DC power generation apparatus.

17. The charging and discharging control apparatus according to 15 or 16, in which the control unit performs charging control of the power storage apparatus when a current value of electric current supplied in a direction from the power system to the AC power line is within a predetermined range.

18. The charging and discharging control apparatus according to any one of 15 to 17, in which the control unit performs charging control of the power storage apparatus according to an increase or decrease in a current amount of a current output from a DC power line to the DC/AC conversion apparatus when a charging amount to the power storage apparatus is increased by a predetermined amount.

19. The charging and discharging control apparatus according to any one of 15 to 18, further including:

a current acquisition unit that acquires a magnitude of a current output from the DC/AC conversion apparatus to the AC power line,

in which the control unit performs charging control of the power storage apparatus based on the magnitude of the current output from the DC/AC conversion apparatus.

20. The charging and discharging control apparatus according to any one of 15 to 19, in which the DC power generation apparatus includes at least one of a photovoltaic power generation facility, a fuel cell, and a private power generation facility utilizing fossil energy.

21. The charging and discharging control apparatus according to any one of 15 to 20,

in which the DC power generation apparatus is a photovoltaic power generation facility, and

the DC/AC conversion apparatus is a Photovoltaics Power Conditioning System (PV-PCS) (Photovoltaics power conditioner).

This application claims priority based on Japanese Patent Application No. 2016-059287 filed on Mar. 23, 2016, the disclosure of which is incorporated herein in its entirety.

1. A charging and discharging control apparatus that controls charging and discharging of a power storage apparatus,
the power storage apparatus being connected to an AC power line, and
the AC power line being connected to a power system, being connected to a DC power generation apparatus through a DC/AC conversion apparatus, and being connectable to a load,
the charging and discharging control apparatus comprising:
an acquisition unit that acquires at least one of a direction and magnitude of electric power flowing between the AC power line and the power system; and
a control unit that controls charging of the power storage apparatus based on a change in at least one of the direction and magnitude of electric power flowing between the AC power line and the power system when a charging amount to the power storage apparatus is increased by a predetermined amount.

2. The charging and discharging control apparatus according to claim 1, wherein the control unit performs charging control of the power storage apparatus based on a presence or absence of an instruction to suppress output of the DC power generation apparatus.

3. The charging and discharging control apparatus according to claim 1, wherein the control unit performs charging control of the power storage apparatus when a current value of electric current supplied in a direction from the power system to the AC power line is within a predetermined range.

4. The charging and discharging control apparatus according to claim 1, wherein the control unit performs charging control of the power storage apparatus according to an increase or decrease in a current amount of a current output from a DC power line to the DC/AC conversion apparatus when a charging amount to the power storage apparatus is increased by a predetermined amount.

5. The charging and discharging control apparatus according to claim 1, further comprising:
a current acquisition unit that acquires the magnitude of the current output from the DC/AC conversion apparatus to the AC power line,
wherein the control unit performs charging control of the power storage apparatus based on the magnitude of the current output from the DC/AC conversion apparatus.

6. The charging and discharging control apparatus according to claim 1, wherein the DC power generation apparatus comprises at least one of a photovoltaic power generation facility, a fuel cell, and a private power generation facility utilizing fossil energy.

7. The charging and discharging control apparatus according to claim 1,
wherein the DC power generation apparatus is a photovoltaic power generation facility, and
the DC/AC conversion apparatus is a Photovoltaics Power Conditioning System (PV-PCS) a Photovoltaics power conditioner.

8. A control method performed by a charging and discharging control apparatus that controls charging and discharging of a power storage apparatus, the power storage apparatus being connected to an AC power line, and the AC power line being connected to a power system, being connected to a DC power generation apparatus through a DC/AC conversion apparatus, and being connectable to a load, the control method performed by the charging and discharging control apparatus comprising:
acquiring at least one of a direction and magnitude of electric power flowing between the AC power line and the power system; and
controlling charging of the power storage apparatus based on a change in at least one of the direction and magnitude of electric power flowing between the AC power line and the power system when a charging amount to the power storage apparatus is increased by a predetermined amount.

9. The control method performed by the charging and discharging control apparatus according to claim 8, further comprising
performing charging control of the power storage apparatus based on a presence or absence of an instruction to suppress output of the DC power generation apparatus.

10. The control method performed by the charging and discharging control apparatus according to claim 8, further comprising
performing charging control of the power storage apparatus when a current value of electric current supplied in a direction from the power system to the AC power line is within a predetermined range.

11. The control method performed by the charging and discharging control apparatus according to claim 8, further comprising: by the charging and discharging control apparatus,
performing charging control of the power storage apparatus according to an increase or decrease in a current amount of a current output from a DC power line to the DC/AC conversion apparatus when the charging amount to the power storage apparatus is increased by a predetermined amount.

12. The control method performed by the charging and discharging control apparatus according to claim 8, further comprising:
acquiring the magnitude of the current output from the DC/AC conversion apparatus to the AC power line; and
performing charging control of the power storage apparatus based on the magnitude of the current output from the DC/AC conversion apparatus.

13. The control method performed by the charging and discharging control apparatus according to claim 8,
wherein the DC power generation apparatus comprises at least one of a photovoltaic power generation facility, a fuel cell, and a private power generation facility utilizing fossil energy.

14. The control method performed by the charging and discharging control apparatus according to claim 8,
wherein the DC power generation apparatus is a photovoltaic power generation facility, and
the DC/AC conversion apparatus is a Photovoltaics Power Conditioning System (PV-PCS) (Photovoltaics power conditioner).

15. A program of a computer for implementing a charging and discharging control apparatus that controls charging and discharging of a power storage apparatus,
the power storage apparatus being connected to an AC power line, and
the AC power line being connected to a power system, being connected to a DC power generation apparatus through a DC/AC conversion apparatus, and being connectable to a load,
the program causing the computer to execute:
a procedure of acquiring at least one of a direction and magnitude of electric power flowing between the AC power line and the power system; and
a procedure of controlling charging of the power storage apparatus based on a change in at least one of the direction and magnitude of electric power flowing between the AC power line and the power system when a charging amount to the power storage apparatus is increased by a predetermined amount.

16. The program according to claim 15, causing the computer to further execute:
a procedure of performing charging control of the power storage apparatus based on the presence or absence of an instruction to suppress output of the DC power generation apparatus.

17. The program according to claim 15, causing the computer to further execute:
a procedure of performing charging control of the power storage apparatus when a current value of electric current supplied in a direction from the power system to the AC power line is within a predetermined range.

18. The program according to claim 15, causing the computer to further execute:
a procedure of performing charging control of the power storage apparatus according to an increase or decrease in the current amount of the current output from the DC power line to the DC/AC conversion apparatus when the charging amount to the power storage apparatus is increased by a predetermined amount.

19. The program according to claim 15, causing the computer to further execute:
a procedure of acquiring a magnitude of the current output from the DC/AC conversion apparatus to the AC power line; and
a procedure of performing charging control of the power storage apparatus based on the magnitude of the current output from the DC/AC conversion apparatus.

20. The program according to claim 15,
wherein the DC power generation apparatus comprises at least one of a photovoltaic power generation facility, a fuel cell, and a private power generation facility utilizing fossil energy.

21. (canceled)
